(19) United States
(12) Patent Application Publication
(10) Pub. No.: US 2026/0241590 A1
(43) Pub. Date: Aug. 20, 2026

(54) SHAVER HEAD

(71) Applicant: WENZHOU MEIBAO TECHNOLOGY CO., LTD., Wenzhou, Zhejiang (CN)

(72) Inventors: Xiangrong Ren, Wenzhou, Zhejiang (CN); Chi Ren, Wenzhou, Zhejiang (CN)

(21) Appl. No.: 18/992,643

(22) PCT Filed: Jul. 27, 2022
(86) PCT No.: PCT/CN2022/108059

§ 371 Date: Jan. 9, 2025

(51) Int. Cl. B26B 21/40; B26B 21/22

(52) U.S. Cl. CPC B26B 21/4031; B26B 21/22

(57) ABSTRACT

A shaver head includes blades and a head frame having an accommodating space. The blades are located in the accommodating space, and blade edges face the front of the head frame; the head frame is provided with a skin pressing contact zone; the distance between a rear side of the skin pressing contact zone and the blade adjacent to the skin pressing contact zone in the front-back direction of the head frame is a, and the distance between a front side of the skin pressing contact zone and the blade adjacent to the skin pressing contact zone is b, wherein 0.30 mm≤a≤1.75 mm and 2.0 mm≤b≤12.1 mm. The pressing area on elastic skin by the skin pressing contact zone is increased, so that the skin is more tensioned by the skin pressing contact zone and the degree of arching is reduced.

### FIELD OF THE INVENTION

The present application relates to the field of shaving, particularly to a shaver head that increases the pressing area on elastic skin during the shaving process, thereby making the elastic skin tighter.

### BACKGROUND OF THE INVENTION

As well known, shavers are commonly used daily necessities. There are mainly two types of shavers, namely electric shavers and manual shavers.

Generally, the manual shaver mainly includes a shaver head and a handle connected to the shaver head. The shaver head mainly includes a head frame and blades assembled on the head frame, with the blades extending in the left-right direction of the head frame, and the cutting edges of the blades facing the front side wall of the head frame. The front side wall has a skin pressing contact part that presses down on the elastic skin during the shaving process.

However, in the existing shaver heads as shown in FIG. 1, the distance b′ between the front side of the skin pressing contact part and the blade 10 adjacent to the front side wall 22, and the distance a′ between the rear side of the skin pressing contact part and the blade 10 adjacent to the front side wall 22 are inappropriate, thus the pressing area of the skin pressing contact part on the elastic skin 200 during the shaving process with the shaver head is small. This results in the position 210 of the elastic skin 200 between the blade 10 and the front side wall 22 not being effectively tightened, causing the elastic skin 200 at the position 210 to protrude in front of the blade 10. Consequently, the blade 10 adjacent to the front side wall 22 is easy to press and cut the protruding part of the elastic skin 200 (i.e., the position 210), affecting the comfort of shaving.

Therefore, there is an urgent need for a shaver head that increases the pressing area on elastic skin during the shaving process, making the elastic skin tighter, to overcome the aforementioned shortcomings.

### SUMMARY OF THE INVENTION

One objective of the present application is to provide a shaver head that increases the pressing area on the elastic skin during the shaving process, thereby making the elastic skin tighter.

To achieve the above-mentioned objective, a shaver head of the present application includes blades and a head frame having an accommodating space. The blades are located in the accommodating space and extended along a left-right direction of the head frame, the blades are assembled in the head frame, and cutting edges of the blades facing a front of the head frame. The head frame is provided with a skin pressing contact zone that is located in front of the blades for pressing down an elastic skin. A distance between a rear side of the skin pressing contact zone and a blade adjacent to the skin pressing contact zone in a front-back direction of the head frame is denoted as a, and a distance between a front side of the skin pressing contact zone and the blade adjacent to the skin pressing contact zone in the front-back direction of the head frame is denoted as b, wherein 0.30 mm≤a≤1.75 mm, and 2.0 mm≤b≤12.1 mm.

Preferably, 0.39 mm≤a≤1.49 mm, and 2.61 mm≤b≤10.51 mm.

Preferably, the skin pressing contact zone is further extended continuously or discontinuously in the left-right direction of the head frame.

Preferably, the head frame has a front side wall located corresponding to a front of the blades, and the skin pressing contact zone is formed by an upper surface of the front side wall.

Preferably, the shaver head further includes a protective member, the head frame has a front side wall located corresponding to a front of the blades, the protective member is assembled from above on the front side wall and extended in the left-right direction of the head frame, the skin pressing contact zone is formed by an upper surface of the protective member, or, a part of the skin pressing contact zone is formed by the upper surface of the protective member, a remaining part of the skin pressing contact zone is formed by the upper surface of the front side wall located between the protective member and the blades.

Preferably, the upper surface of the front side wall located between the protective member and the blades is joined together with the upper surface of the protective member.

Preferably, the upper surface of the front side wall located between the protective member and the blades is lower than the upper surface of the protective member.

Preferably, the skin pressing contact zone is an arcuate curved surface area or a flat area.

Preferably, the head frame further has a rear side wall located corresponding to the front of the blades, and the blades are arranged separately in the front-back direction of the head frame.

Preferably, all the blades are arranged in an increasing height from front to back along the head frame, the blade adjacent to the skin pressing contact zone is lower than a straight line connecting a highest point on the upper surface of the rear side wall and a highest point of the skin pressing contact zone, and other blade adjacent to the rear side wall are higher than the straight line connecting the highest point on the upper surface of the rear side wall and the highest point of the skin pressing contact zone.

In comparison with the prior art, the head frame of the present application has a skin pressing contact zone located in front of the blades for pressing down the elastic skin, the rear side of the skin pressing contact zone along the front and back direction of the head frame is spaced apart from the blade adjacent to the skin pressing contact zone by a distance a, and the front side of the skin pressing contact zone along the front and back direction of the head frame is spaced apart from the blade adjacent to the skin pressing contact zone by a distance b, where 0.30 mm≤a≤1.75 mm, 2.0 mm≤b≤12.1 mm, thus the dimensions between the front and rear sides of the skin pressing contact zone satisfy 1.70 mm≤b-a≤10.35 mm. This ensures that the shaver head of the present application maximizes the pressing area of the skin pressing contact zone on the elastic skin during the shaving process within the size range allowed by industry standards (i.e., national standards). Therefore, for the same unit of elastic skin, under the premise of the same pressing distance, the pressing area of the skin pressing contact zone on the elastic skin is at its maximum range, thus making the elastic skin tighter. For example, taking an elastic rubber strip as an example, for the same length of an elastic rubber strip with both ends constrained and fixed, the degree to which the elastic rubber strip is tightened by one finger pressing down is far less than the degree to which it is tightened by two fingers pressing down. This reduces the degree of arching of the elastic skin at position between the skin pressing contact zone and the adjacent blade, thereby achieving the purpose of reducing skin irritation.

### BRIEF DESCRIPTION OF THE DRAWINGS

FIG. 1 is a state diagram showing the relationship between the conventional shaver and elastic skin during shaving.

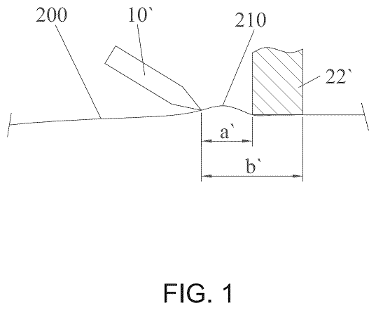

FIG. 2 is an internal diagram of the shaver according to the first embodiment of the present application.

FIG. 3 is an internal diagram of the shaver of FIG. 2 with a straight line connection shown.

FIG. 4 is a plan view of the head frame shown in FIG. 2.

FIG. 5 is a plan view of the head frame shown in FIG. 4, with the skin pressing contact zone shown by a dashed line.

FIG. 6 is a plan view of the skin pressing contact zone in the head frame shown in FIG. 5 according to a modified embodiment.

FIG. 7 is an internal diagram of the shaver according to the second embodiment of the present application.

FIG. 8 is an internal diagram of the shaver according to the third embodiment of the present application.

FIG. 9 is a state diagram showing the relationship between the shaver of the present application and the elastic skin.

### DETAILED DESCRIPTION OF ILLUSTRATED EMBODIMENTS

To explain the technical content and structural features of the present application in detail, the following description is made in conjunction with the embodiments and accompanying drawings.

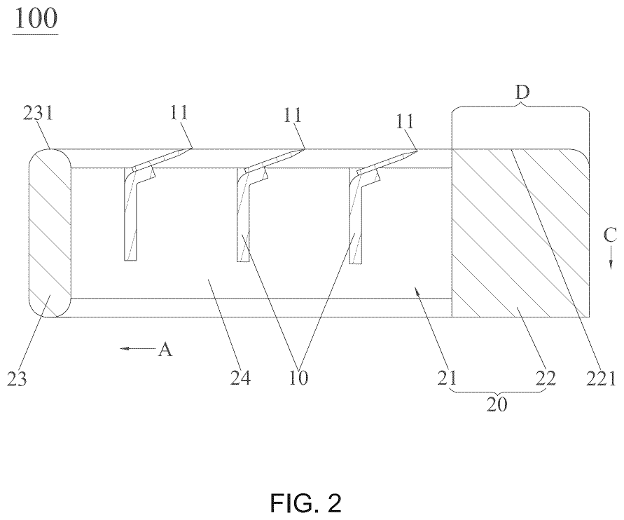

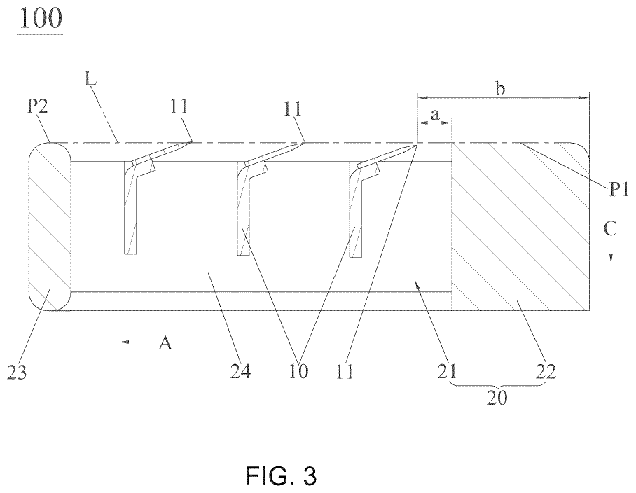

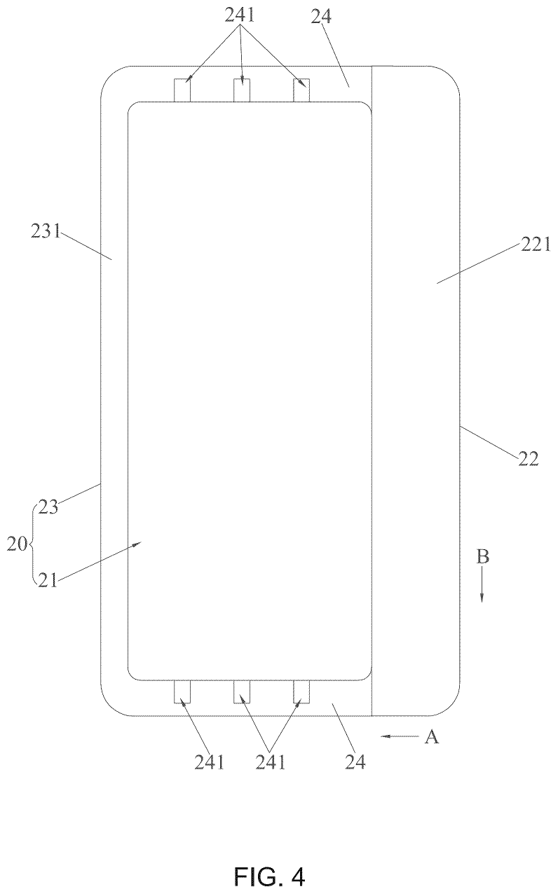

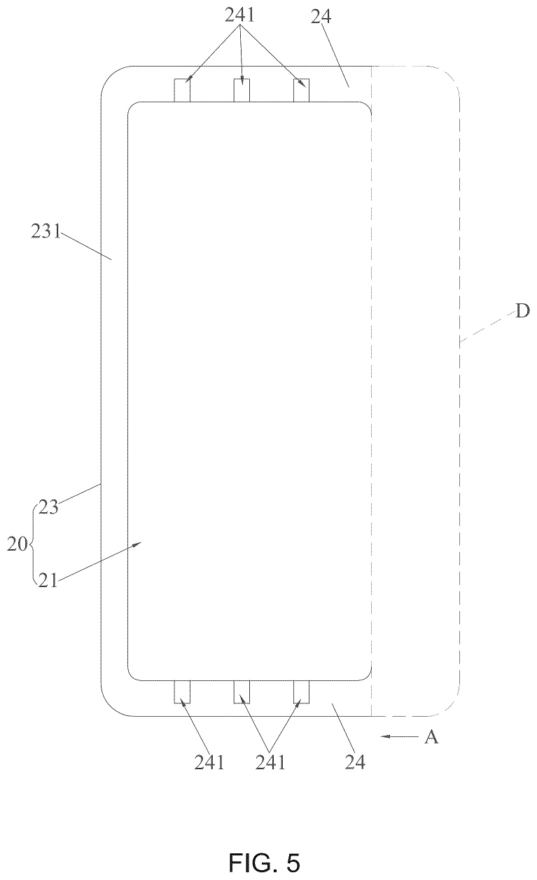

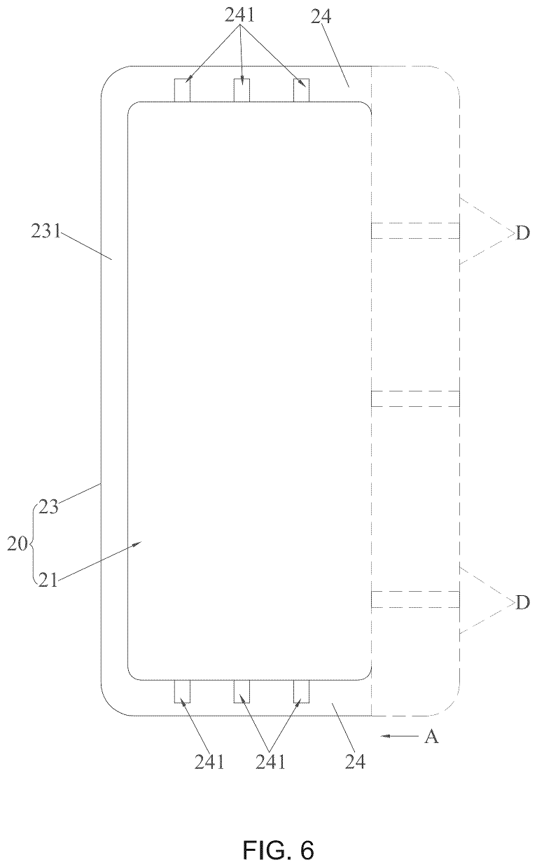

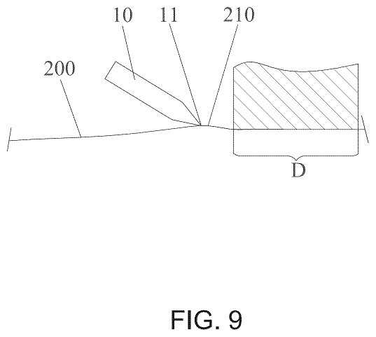

Refer to FIGS. 2 and 3, the shaver head 100 of the first embodiment of the present application includes blades 10 and a head frame 20 with an accommodating space 21. Preferably, as shown in FIGS. 4 to 6, the accommodating space 21 is a square structure with rounded corners to facilitate the processing and manufacturing of the accommodating space 21. Of course, according to actual needs, the accommodating space 21 can also be designed as a square structure without rounded corners, or other shapes, which is not limited to that shown in FIGS. 4 to 6. The blades 10 are located in the accommodating space 21 and extended in the left-right direction of the head frame 20, which facilitates the removal of hair shaved by the blades 10 from the accommodating space 21, as well as the cleaning and maintenance of the blades 10. The blades 10 are assembled at the head frame 20, which provides support and space for the blades 10, and the cutting edges 11 of the blades 10 face the front of the head frame 20. Specifically, the blades 10 are assembled at the intermediate connecting side wall 24 described hereinafter, which connects to the front side wall 22 and the rear side wall 23 described hereinafter. The intermediate connecting side wall 24 has an assembly channel 241 for the blades 10 to be assembled from the top of the head frame 20 downward into the intermediate connecting side wall 24. This design facilitates the assembly and disassembly operations of the blades 10 at the head frame 20. Preferably, the intermediate connecting side walls 24 are arranged opposite at left and right sides. Correspondingly, the left and right ends of the blades 10 are respectively assembled in the assembly channels 241 of the intermediate connecting side walls 24 at the same end, which is not limited however. At the same time, the head frame 20 has a skin pressing contact zone D located in front of the blades 10 for pressing down the elastic skin 200 (referring to FIG. 9), the rear side of the skin pressing contact zone D along the front-back direction of the head frame 20 is spaced apart from the blade 10 adjacent to the skin pressing contact zone D by a distance a, and the front side of the skin pressing contact zone D along the front and back direction of the head frame 20 is spaced apart from the blade 10 adjacent to the skin pressing contact zone D by a distance b, where 0.30 mm≤a≤1.75mm, 2.0 mm≤b≤12.1 mm, so that the dimensions between the front and rear sides of the skin pressing contact zone D satisfy 1.70 mm≤b-a≤10.35 mm, thereby ensuring that the shaver head 100 of the first embodiment of the present application maximizes the pressing area of the skin pressing contact zone D on the elastic skin 200 during the shaving process within the size range allowed by industry standards (i.e., national standards). It should be noted that in FIG. 5, the dashed line box indicated by reference number D is the skin pressing contact zone, while in FIG. 6, the four dashed line boxes indicated by reference number D are the skin pressing contact zones. That is to say, the skin pressing contact zone D in FIG. 5 is extended continuously in the left-right direction of the head frame 20; while in FIG. 6, the skin pressing contact zones D are extended discontinuously in the left-right direction of the head frame 20.

More specifically, As shown in FIGS. 3, 0.39 mm≤a≤1.49 mm, and 2.61 mm≤b≤10.51 mm, it's apparent that the dimensions between the front and rear sides of the skin pressing contact zone D satisfy 2.22 mm≤b-a≤9.02 mm, thus the distance a between the rear side of the skin pressing contact zone D and the adjacent blade 10 is effectively balanced with the dimensions between the front and rear sides of the skin pressing contact zone D, ensuring that the distance a is at an optimal size while maximizing the dimensions between the front and rear sides of the skin pressing contact zone D, thereby optimizing the pressing area of the skin pressing contact zone D. For example, if 5.0 mm≤b-a≤6.0 mm, presuming that a is 0.39 mm, thus 5.39 mm≤b≤6.39 mm; presuming that a is 0.5 mm, thus 5.5 mm≤b-a≤6.5 mm; presuming a is 1.0 mm, thus 6.0 mm≤b-a≤7.0 mm; presuming a is 1.49 mm, thus 6.49 mm≤b-a≤7.49 mm. It should be noted that mm stands for millimeters.

As shown in FIG. 2, the head frame 20 has a front side wall 22 located in front of the blades 10, and the skin pressing contact zone D is formed by the upper surface 221 of the front side wall 22, which makes the manufacturing of the skin pressing contact zone D easier. Preferably, in FIG. 5, the skin pressing contact zone D is formed on the entire upper surface 221 of the front side wall 22; while in FIG. 6, the skin pressing contact zone D is not formed by the entire upper surface 221 of the front side wall 22. Instead, the skin pressing contact zones D are extended discontinuously in the left-right direction of the head frame 20, which is not limited to this however. Further, the head frame 20 also has a rear side wall 23 located behind the blades 10. In this embodiment, three blades 10 are arranged separately in the front-back direction of the head frame 20. Optionally, according to actual needs, the one or more blades 10 can also be arranged, which is not limited to that shown in the figures. Specifically, in FIG. 2, the skin pressing contact zone D is a flat area, so that the skin pressing contact zone D presses down on the elastic skin 200 in a flat contact manner. Optionally, according to actual needs, the skin pressing contact zone D can also be an arcuate curved surface area, thereby facilitating the skin pressing contact zone D to slide smoothly along the elastic skin 200. Furthermore, all blades 10 are arranged in an increasing height from front to back along the head frame 20, the blade 10 adjacent to the skin pressing contact zone D is lower than the straight line L connecting the highest point P2 on the upper surface 231 of the rear side wall 23 and the highest point P1 of the skin pressing contact zone D. That is, the blade 10 adjacent to the skin pressing contact zone D has a negative exposure amount (namely no protrusion) from the head frame 20. The blade 10 adjacent to the rear side wall 23 is higher than the straight line L connecting the highest point P2 on the upper surface 231 of the rear side wall 23 and the highest point P1 of the skin pressing contact zone D. That is, the blade 10 adjacent to the rear side wall 23 has a positive exposure amount (namely protrusion) from the head frame 20. Therefore, the blades 10 are arranged in a manner which has then exposure amount from negative to positive, thereby achieving a shaving process from deep to shallow.

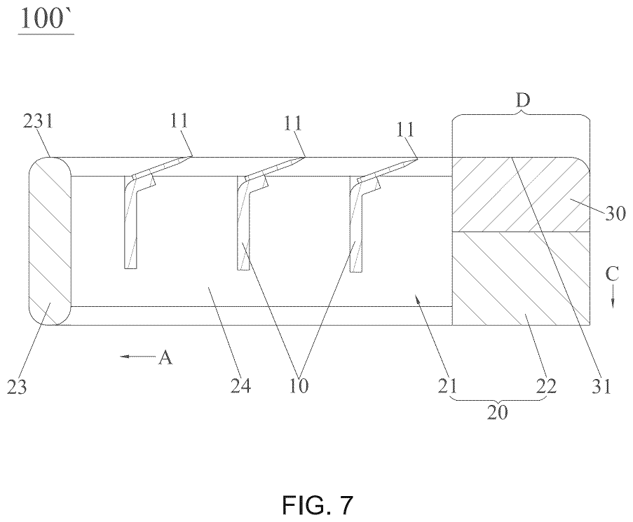

Referring to FIG. 7, the shaver head 100′ of the second embodiment of the present application has essentially the same structure as the shaver head 100 of the first embodiment of the present application, with the following differences.

In the shaver head 100′ of the second embodiment of the present application, a protective member 30 is further included. The head frame 20 has a front side wall 22 located in front of the blades 10, and the protective member 30 is assembled from above on the front side wall 22 and extended in the left-right direction of the head frame 20. Since the protective member 30 fully covers the upper part of the front side wall 22, the skin pressing contact zone D is formed by the upper surface 31 of the protective member 30. While in the shaver head 100 of the first embodiment of the present application, no protective member 30 is included, and the skin pressing contact zone D is formed by the upper surface 221 of the front side wall 22.

Apart from the above difference, the rest structure is the same as the shaver head 100 of the first embodiment of the present application, which will not be repeated here.

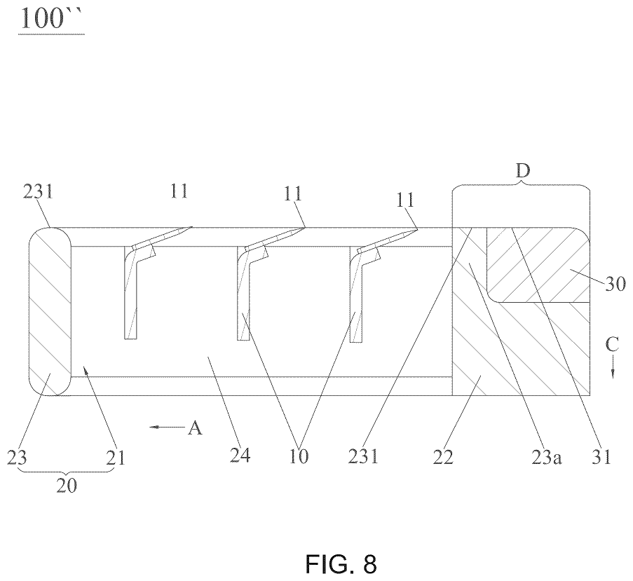

Referring to FIG. 8, the shaver head 100″ of the third embodiment of the present application has essentially the same structure as the shaver head 100 of the first embodiment of the present application, with the following differences.

First, in the shaver head 100″ of the third embodiment of the present application, a protective member 30 is further included. The head frame 20 has a front side wall 22 located in front of the blade 10. The protective member 30 is assembled from above on the front side wall 22 and extended in the left-right direction of the head frame 20. The protective member 30 partially covers the upper part of the front side wall 22, thus the position 23a of the front side wall 22 between the protective member 30 and the blades 10 is exposed. Therefore, a part of the skin pressing contact zone D is formed by the upper surface 31 of the protective member 30, and the remaining part of the skin pressing contact zone D is formed by the upper surface 231 of the position 23a of the front side wall 22 between the protective member 30 and the blade 10. In contrast, the shaver head 100 of the first embodiment of the present application provides no protective member 30, and correspondingly, the skin pressing contact zone D is formed by the upper surface 221 of the front side wall 22.

Second, in the shaver head 100″ of the third embodiment of the present application, the upper surface 231 of the position 23a of the front side wall 22 between the protective member 30 and the blades 10 is joined together with the upper surface 31 of the protective member 30. Preferably, the upper surface 231 of the position 23a of the front side wall 22 between the protective member 30 and the blades 10 is flush with the upper surface 31 of the protective member 30. Optionally, according to actual needs, it is also possible to make the upper surface 231 of the position 23a of the front side wall 22 between the protective member 30 and the blades 10 lower than the upper surface 31 of the protective member 30, which is not limited to that shown in FIG. 8.

Apart from the differences mentioned above, the rest structure is the same as the shaver head 100 of the first embodiment of the present application, which will not be repeated here.

Compared to the prior art, the head frame 20 of the present application has a skin pressing contact zone D located in front of the blades 10 for pressing down the elastic skin 200, the rear side of the skin pressing contact zone D along the front and back direction of the head frame 20 is spaced apart from the blade 10 adjacent to the skin pressing contact zone D by a distance a, and the front side of the skin pressing contact zone D along the front and back direction of the head frame 20 is spaced apart from the blade 10 adjacent to the skin pressing contact zone D by a distance b, where 0.30 mm≤a≤1.75 mm, 2.0 mm≤b≤12.1 mm, thus the dimensions between the front and rear sides of the skin pressing contact zone D satisfy 1.70 mm≤b-a≤10.35 mm. This ensures that the shaver head 100 (100′, 100″) of the present application maximizes the pressing area of the skin pressing contact zone D on the elastic skin 200 during the shaving process within the size range allowed by industry standards (i.e., national standards). Therefore, for the same unit of elastic skin 200, under the premise of the same pressing distance, the pressing area of the skin pressing contact zone D on the elastic skin is at its maximum range, thus making the elastic skin tighter. For example, taking an elastic rubber strip as an example, for the same length of an elastic rubber strip with both ends constrained and fixed, the degree to which the elastic rubber strip is tightened by one finger pressing down is far less than the degree to which it is tightened by two fingers pressing down. This reduces the degree of arching of the elastic skin 200 at position 210 between the skin pressing contact zone D and the adjacent blade 10, as shown in FIG. 9, thereby achieving the purpose of reducing skin irritation.

It should be noted that in the drawings, the arrow A indicates the direction from front to back of the head frame 20, the arrow B indicates the direction from left to right of the head frame 20, and the arrow C indicates the direction from top to bottom of the head frame 20.

The above disclosure is only exemplary embodiments of the present application, and it should not be construed to limit the scope of the present application. Therefore, equivalent changes made according to the claims of the present application are still within the scope covered by the present application.

1. A shaver head, comprising blades and a head frame having an accommodating space, the blades being located in the accommodating space and extended along a left-right direction of the head frame, the blades being assembled in the head frame, and cutting edges of the blades facing a front of the head frame; the head frame being provided with a skin pressing contact zone that is located in front of the blades for pressing down an elastic skin;
wherein a distance between a rear side of the skin pressing contact zone and a blade adjacent to the skin pressing contact zone in a front-back direction of the head frame is denoted as a, and a distance between a front side of the skin pressing contact zone and the blade adjacent to the skin pressing contact zone in the front-back direction of the head frame is denoted as b, wherein 0.30 mm≤a≤1.75 mm, and 2.61 mm≤b≤10.51 mm.

2. The shaver head according to claim 1, wherein 0.39 mm≤a≤1.49 mm,

3. The shaver head according to claim 1, wherein the skin pressing contact zone is further extended continuously or discontinuously in the left-right direction of the head frame.

4. The shaver head according to claim 1, wherein the head frame has a front side wall located corresponding to a front of the blades, and the skin pressing contact zone is formed by an upper surface of the front side wall.

5. The shaver head according to claim 1, further comprising a protective member, wherein the head frame has a front side wall located corresponding to a front of the blades, the protective member is assembled from above on the front side wall and extended in the left-right direction of the head frame, the skin pressing contact zone is formed by an upper surface of the protective member, or, a part of the skin pressing contact zone is formed by the upper surface of the protective member, a remaining part of the skin pressing contact zone is formed by the upper surface of the front side wall located between the protective member and the blades.

6. The shaver head according to claim 5, wherein the upper surface of the front side wall located between the protective member and the blades is joined together with the upper surface of the protective member.

7. The shaver head according to claim 5, wherein the upper surface of the front side wall located between the protective member and the blades is lower than the upper surface of the protective member.

8. The shaver head according to claim 4, wherein the skin pressing contact zone is an arcuate curved surface area or a flat area.

9. The shaver head according to claim 4, wherein the head frame further has a rear side wall located corresponding to the front of the blades, and the blades are arranged separately in the front-back direction of the head frame.

10. The shaver head according to claim 9, wherein all the blades are arranged in an increasing height from front to back along the head frame, the blade adjacent to the skin pressing contact zone is lower than a straight line connecting a highest point on the upper surface of the rear side wall and a highest point of the skin pressing contact zone, and another blade adjacent to the rear side wall is higher than the straight line connecting the highest point on the upper surface of the rear side wall and the highest point of the skin pressing contact zone.

11. The shaver head according to claim 5, wherein the skin pressing contact zone is an arcuate curved surface area or a flat area.

12. The shaver head according to claim 5, wherein the head frame further has a rear side wall located corresponding to the front of the blades, and the blades are arranged separately in the front-back direction of the head frame.

13. The shaver head according to claim 12, wherein all the blades are arranged in an increasing height from front to back along the head frame, the blade adjacent to the skin pressing contact zone is lower than a straight line connecting a highest point on the upper surface of the rear side wall and a highest point of the skin pressing contact zone, and another blade adjacent to the rear side wall is higher than the straight line connecting the highest point on the upper surface of the rear side wall and the highest point of the skin pressing contact zone.
